(19) United States
(12) Patent Application Publication
(10) Pub. No.: US 2016/0045058 A1
(43) Pub. Date: Feb. 18, 2016

(54) CONTAINER HAVING FILTER

(71) Applicant: HSIAO CHENG CHUANG, Taoyuan County (TW)

(72) Inventor: HSIAO CHENG CHUANG, Taoyuan County (TW)

(21) Appl. No.: 14/462,487

(22) Filed: Aug. 18, 2014

(51) Int. Cl. A47J 31/06

(52) U.S. Cl. CPC A47J 31/06

(57) ABSTRACT

A container having a filter includes a main body, the filter, a cover, and a top lid. The cover is formed with a central opening. The inner bottom edge of the opening is attached to the filter. The cover is adapted to cover the top edge of the main body. The top lid is adapted to cover the opening of the cover. When making tea, the user just lifts the top lid and puts some tea leaves into the filter for brewing tea. After brewing tea, the cover and the filter can be taken away directly, so that the user can drink the tea in the main body. It is quite convenient for use.

### BACKGROUND OF THE INVENTION

1. Field of the Invention

The present invention relates to a drinking water container, and more particularly to a container made of heat-resistant plastic and able to separate tea leaves from tea.

2. Description of the Prior Art

Water is very important for the human body. Proper water is required daily to maintain the normal operation of bodily functions. Through experimental researches, it is known that tea is helpful for human health. Drinking adequate tea becomes a daily habit for many people. However, when making tea, people may drink few tea leaves unexpectedly. This is troublesome. Preparing for a teapot and cups, like the traditional tea ceremony, is troublesome and inconvenient. Besides, if the tea leaves are brewed over, the tea will taste bitter. Therefore, it is necessary to design an ideal cup/pot for making tea. Accordingly, the inventor of the present invention has devoted himself based on his many years of practical experiences to solve these problems.

### SUMMARY OF THE INVENTION

The primary object of the present invention is to improve the problem of the prior art and to provide a container having a filter to separate tea leaves from tea with ease. It is quite convenient and practical for drinking tea.

A further object of the present invention is to provide a container having a filter to separate tea leaves from tea with ease. After brewing tea, it is convenient to take out the tea leaves, such that the tea won't taste bitter because the tea leaves are brewed over.

In order to achieve the above-mentioned objects, the container of the present invention comprises a main body, a filter, a cover, and a top lid. The main body has a first space therein. The filter has a second space therein. The filter is formed with a plurality of through apertures. The cover is formed with a central opening, a retaining ring beside the top edge of the opening, and a concave ring around the outer wall of the cover. The concave ring is adapted to receive a washer. The bottom edge of the opening is coupled to the filter.

The top of the top lid is formed with a protrusion.

The cover is placed on top of the first space of the main body. The top lid is adapted to cover the opening of the cover.

When making tea, the user just lifts the top lid and puts some tea leaves into the second space of the filter for brewing tea. After brewing tea, the cover and the filter can be taken away directly, so that the user can drink the tea in the main body or put the cover and the top lid on the main body. It is quite convenient for use.

### BRIEF DESCRIPTION OF THE DRAWINGS

FIG. 1 is an exploded view the present invention;

FIG. 2 is a perspective view the present invention; and

FIG. 3 is a sectional view the present invention.

### DETAILED DESCRIPTION OF THE PREFERRED EMBODIMENTS

Embodiments of the present invention will now be described, by way of example only, with reference to the accompanying drawings.

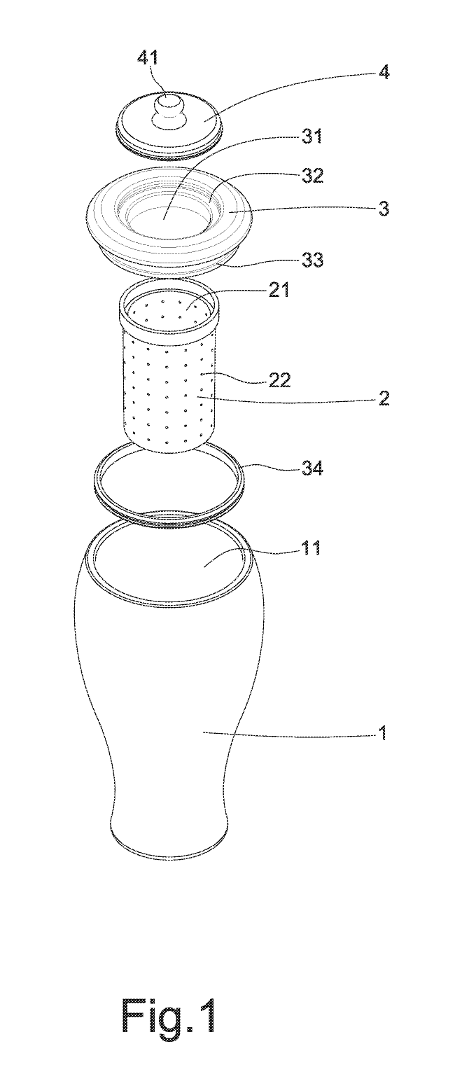

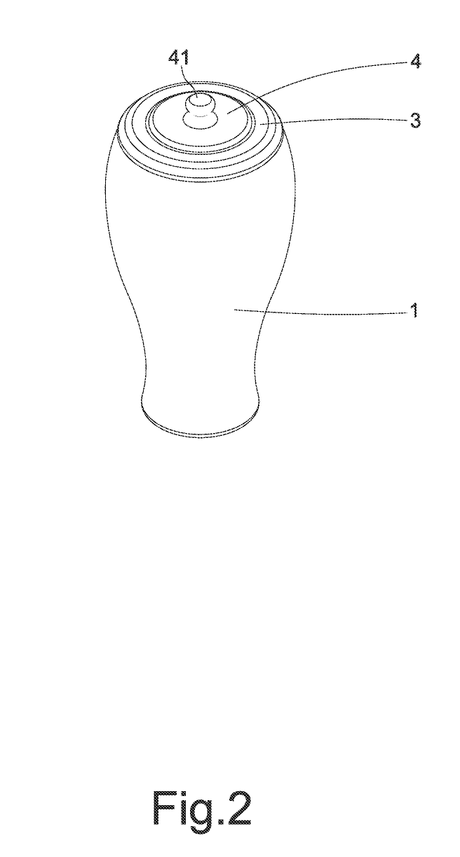

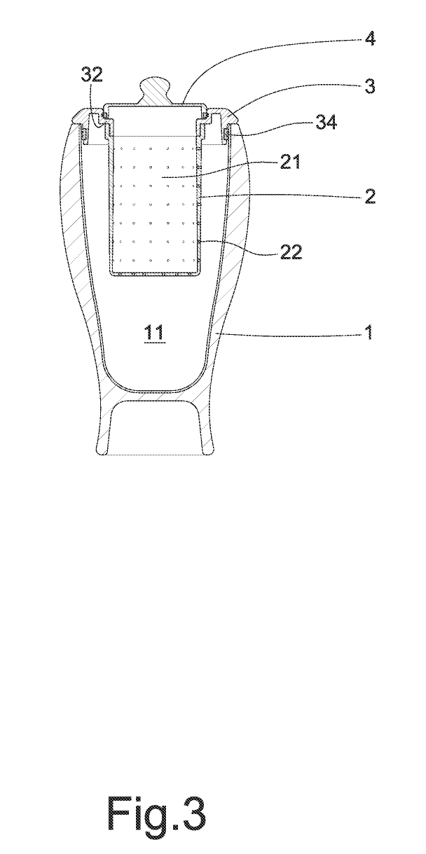

Referring to FIG. 1, FIG. 2, and FIG. 3, the present invention discloses a container having a filter. The container comprises a main body 1, a filter 2, a cover 3, and a top lid 4. The main body 1 has a first space 11 therein. The filter 2 has a second space 21 therein. The filter 2 is formed with a plurality of through apertures 22. The top of the filter 2 is attached to the bottom edge of the top lid 4. The cover 3 is formed with a central opening 31, a retaining ring 32 beside the top edge of the opening 31, and a concave ring 33 around the outer wall of the cover 3. The concave ring 33 is adapted to receive a washer 34. The top of the top lid 4 is formed with a protrusion 41.

To assemble the present invention, the cover 3 is placed on top of the first space 11 of the main body 1. The top lid 4 is to cover the opening 31 of the cover 3.

When the user wants to make tea, the top lid 4 is lifted and then some tea leaves are put into the second space 21 of the filter 2 with ease. After that, hot water is poured for making tea. By the through apertures 22, the first space 11 communicates with the second space 21 so that tea can flow therebetween. After brewing tea, the cover 3 and the filter 2 are taken out so that the user can drink the tea in the main body 1. Alternatively, the cover 3 and the top lid 4 are used to cover the main body 1 so as to keep warm. It is quite convenient for use.

The protrusion 41 of the top lid 4 is for the fingers of the user to hold thereon.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A container having a filter, comprising:
a main body, the main body having a first space therein;
the filter having a second space therein, the filter being formed with a plurality of through apertures;
a cover, the cover being formed with a central opening and a retaining ring beside the opening, a bottom edge of the opening being coupled to a top of the filter; and
a top lid.

2. The container having a filter as claimed in claim 1, wherein the cover has a concave ring around an outer wall thereof, and the concave ring is adapted to receive a washer.

3. The container having a filter as claimed in claim 1, wherein a top of the top lid is formed with a protrusion.
